(19) United States
(12) Patent Application Publication
(10) Pub. No.: US 2021/0391890 A1
(43) Pub. Date: Dec. 16, 2021

(54) REFERENCE SIGNAL DISTRIBUTION IN MULTI-MODULE SYSTEMS

(71) Applicant: VAYYAR IMAGING LTD., Yehud (IL)

(72) Inventors: Naftali Chayat, Kfar Saba (IL); Jonathan Rosenfeld, Ramat Hasharon (IL)

(73) Assignee: VAYYAR IMAGING LTD., Yehud (IL)

(21) Appl. No.: 17/460,365

(22) Filed: Aug. 30, 2021

Related U.S. Application Data
(63) Continuation-in-part of application No. 17/067,893, filed on Oct. 12, 2020, now Pat. No. 11,108,428.
Application No. 17/067,893 is a continuation of application No. 16/704,009, filed on Dec. 5, 2019, now Pat. No. 10,804,954.
Application No. 16/704,009 is a continuation of application No. 16/008,068, filed on Jun. 14, 2018, now abandoned.
Application No. 16/008,068 is a division of application No. 15/473,884, filed on Mar. 30, 2017, now Pat. No. 10,020,836.
Application No. 15/473,884 is a continuation of application No. PCT/IL2015/050973, filed on Sep. 24, 2015.
(60) Provisional application No. 62/057,286, filed on Sep. 30, 2014.

(51) Int. Cl. H04B 1/48; H04B 17/12; H04B 17/14; H04B 17/21

(52) U.S. Cl. CPC H04B 1/48; H04B 17/21; H04B 17/14; H04B 17/12

(57) ABSTRACT

Systems of multiple transmitters and multiple receivers, allowing receivers to identify the transmitters from which reference signals originate. Identification is according to frequency offset patterns based on transmitter and local oscillator frequencies, and is particularly suitable in radio-frequency integrated-circuit devices and MIMO radar systems. Also disclosed are variations of passive reference signal distribution cavities for efficient, cost-effective distribution of reference signals in multi-module systems.

This application is a Continuation-In-Part Application of U.S. patent application Ser. No. 17/067,893, filed Oct. 12, 2020, titled ‘Reference signal distribution in multi-module systems’, which is a Continuation Application of U.S. patent application Ser. No. 16/704,009, filed Dec. 5, 2019 titled ‘Reference signal distribution in multi-module systems’, which is a Continuation Application of U.S. patent application Ser. No. 16/008,068, filed Jun. 14, 2018, titled ‘Reference signal distribution in multi-module systems’, which is a Divisional Application of U.S. patent application Ser. No. 15/473,884, filed Mar. 30, 2017, titled ‘Reference signal distribution in multi-module systems’, which is a continuation of PCT International Application No. PCT/IL2015/050973, International Filing Date Sep. 24, 2015, claiming priority of U.S. Provisional Patent Application No. 62/057,286, filed Sep. 30, 2014.

### FIELD

The present invention is directed to multi-module radio-frequency calibration, in particular to the calibration of radio frequency integrated circuits (RFIC).

### BACKGROUND

Multi-module systems typically require sharing of frequency and phase reference signals for real-time calibration. In such systems, it is desirable to measure transmission characteristics between arbitrarily-selected ports of the modules. For example, in a phased-array radar system it is necessary to know the relative phase characteristics at the respective antennas in order to be able to direct a phased beam in a particular direction. In another example, multiple input/multiple output (MIMO) radar systems require referencing received signals to one another.

Under ideal conditions, measurement of reference signals is generally straightforward. When transmission losses are high, however, signal leakage among module ports interferes with reference measurement, For example, when making multi-port measurements with a vector network analyzer (VNA) there is typically some signal leakage between the VNA's ports, which limits the dynamic range of the measurements. This problem is particularly pronounced in the case of a single RFIC, where the isolation is limited because of the small inter-port distances and the inherently-restricted isolation of the RFIC, the package, and the printed circuit board (PCB). Here, the likely limit for isolation is on the order of 50 dB, achieved between the most distantly-separated RFIC ports.

A known improvement to the above-described isolation problem is to use a separate shielded RFIC for each port. In this way, the signal transmitted to the device (or medium) under test (hereinafter denoted as “DUT”) has a significantly better isolation, and only the signal passing through the DUT reaches the other RFIC. Unfortunately, however, this introduces the problem of providing a phase reference to the mated RFIC. RFICs may have distinct synthesizers, so the phase of a signal from one RFIC downconverted within another RFIC cannot be directly measured—only comparative measurements can be made. This requires that a sample of the reference signal be provided to the receiving RFIC. The straightforward approach for providing the reference is to bring a sample of the transmitted signal to the receiving RFIC via a receiving port, and then measure the phase difference between the signal from the DUT and the reference signal from the transmitting RFIC. However, bringing a signal at the test frequency can contaminate the signal from the DUT, because the receiving RFIC has limited isolation. The problem could be lessened by weakening the reference signal, but doing so also reduces measurement accuracy because of the degraded signal-to-noise ratio of the reference.

Under the conditions and restrictions described above, it would be desirable to have methods for reducing or eliminating signal leakage; reducing or eliminating the affects of signal leakage on measurements; and making accurate measurements in spite of signal leakage. These goals are met by embodiments of the present invention.

### SUMMARY

Various embodiments of the present invention provide efficient and ordered distribution of reference signals in RF systems having multiple receivers and transmitters. These embodiments provide reference sharing among the different ports of the modules, in configurations including, but not limited to: a star coupler featuring all-to-all reference coupling; and neighboring module-to-module reference sharing.

In addition, certain embodiments of the present invention provide isolation for reference signals that are being shared among modules, by furnishing each reference signal with a unique signature, allowing individual reference signals to be identified and separated as necessary throughout the system. According to various embodiments of the invention, signatures can be applied via frequency-shifting or binary phase-shift encoding.

Therefore, according to an embodiment of the present invention there is provided a radio-frequency transmitter-receiver system including: (a) a transmitter for transmitting a transmitted signal at a transmission frequency; (b) a receiver for receiving the transmitted signal as a received transmitted signal, wherein: (c) the receiver includes a local oscillator having a local oscillator signal at a local oscillator frequency, for downconverting the received transmitted signal from the transmission frequency to an intermediate frequency as a receiver intermediate frequency signal; (d) a transmitter downconverter associated with the transmitter, for downconverting the transmitted signal from the transmission frequency to the intermediate frequency as a transmitter intermediate frequency signal; (e) a reference signal path from the local oscillator to the transmitter downconverter, for conveying the local oscillator signal from the local oscillator to the transmitter downconverter; and (f) a phase comparator, for measuring a phase difference between the receiver intermediate frequency signal and the transmitter intermediate frequency signal.

In addition, according to another embodiment of the present invention, there is also provided a method for calibrating a radio-frequency transmitter-receiver system having a transmitter with a transmitted signal, a receiver with a local oscillator signal and a receiver intermediate frequency signal, and a transmitter downconverter, the method including: (a) downconverting the transmitted signal via the downconverter to a transmitter intermediate frequency signal according to the local oscillator signal; (b) measuring a phase difference between the receiver intermediate frequency signal and the transmitter intermediate frequency signal; and (c) calibrating the transmitter-receiver system according to the phase difference.

### BRIEF DESCRIPTION OF THE DRAWINGS

The subject matter disclosed may best be understood by reference to the following detailed description when read with the accompanying drawings in which:

FIG. 1 is a top-level block diagram of a radio-frequency integrated circuit (RFIC).

FIG. 2 is a block diagram of an exemplary transmit/receive module.

FIG. 3 is a block diagram of a system of two RFICs.

FIG. 4A is a block diagram of a multi-module RFIC system having bidirectional ports used for calibration.

FIG. 4B is a block diagram of a multi-module RFIC system having dedicated ports used for calibration.

FIG. 5A is a block diagram showing a reference signal sent from a transmitting module to a receiving module.

FIG. 5B is a block diagram showing a reference signal sent from a receiving module to a transmitting module.

FIG. 6A is a schematic diagram of a simplified symmetric star coupler.

FIG. 6B is a block diagram of a symmetric all-to-all reference signal distributor.

FIG. 6C is a block diagram of an exemplary 8-port all-to-all Butler/Hadamard coupler.

FIG. 6D is an illustration of an exemplary Rotman-lens based coupler.

FIG. 6E is an illustration of an exemplary folded Rotman-lens based coupler.

FIG. 6F is an illustration of an exemplary circular waveguide cavity based coupler.

FIG. 7A is an illustration of automotive radar with cavity-based reference signal distribution.

FIG. 7B is an illustration of a planar security scanner with cavity-based reference signal distribution.

FIG. 7C is an illustration of a curved security scanner with cavity-based reference signal distribution.

FIG. 7D is an illustration of a pass-through security scanner with cavity-based reference signal distribution

FIG. 8A is an illustration of a distribution cavity with a backside mirror.

FIG. 8B is an illustration of a planar radial waveguide distribution cavity.

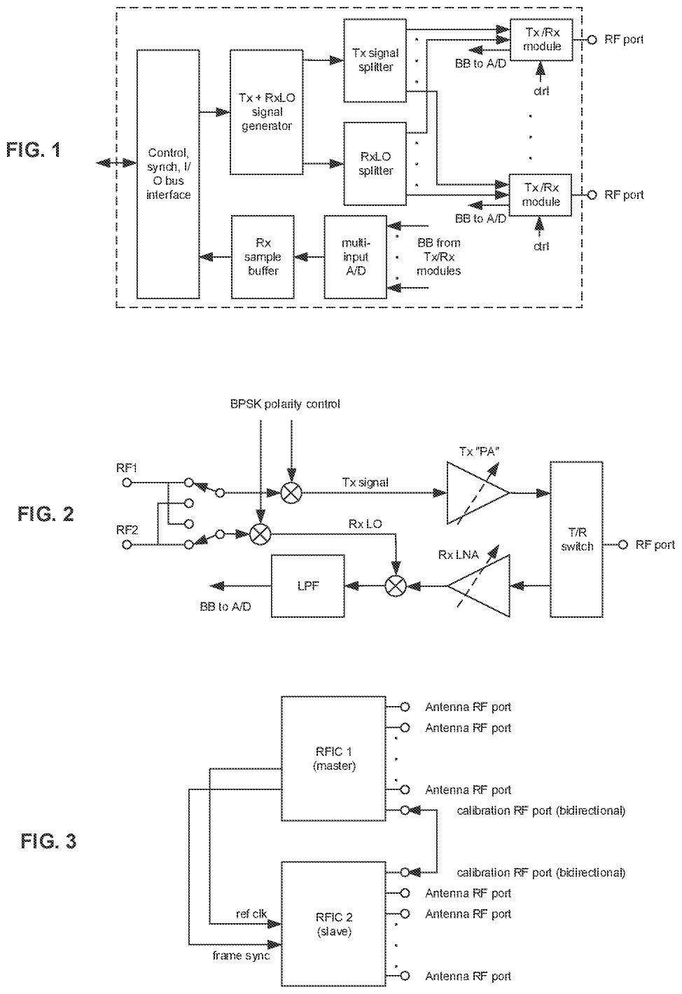

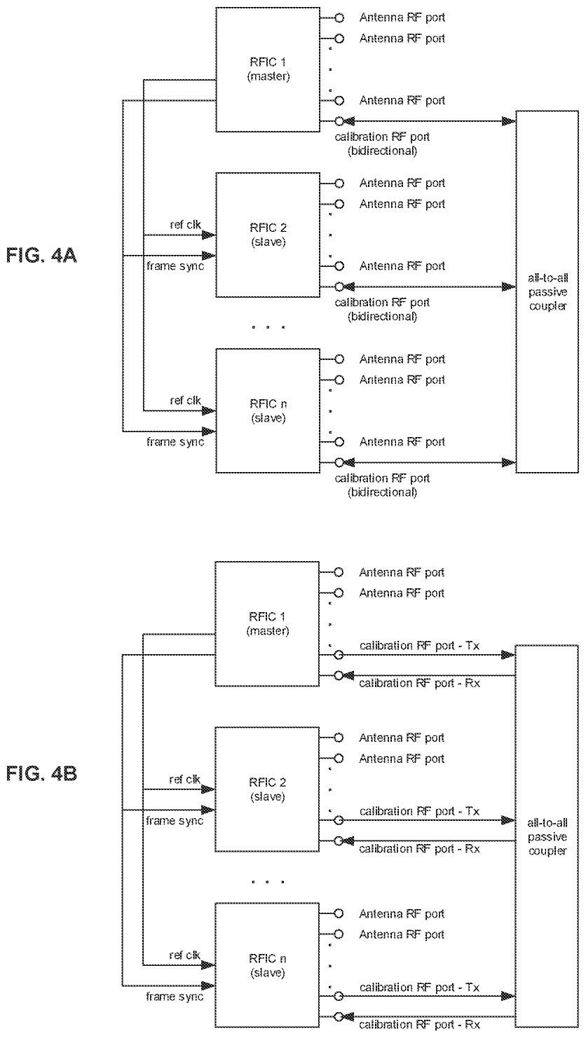

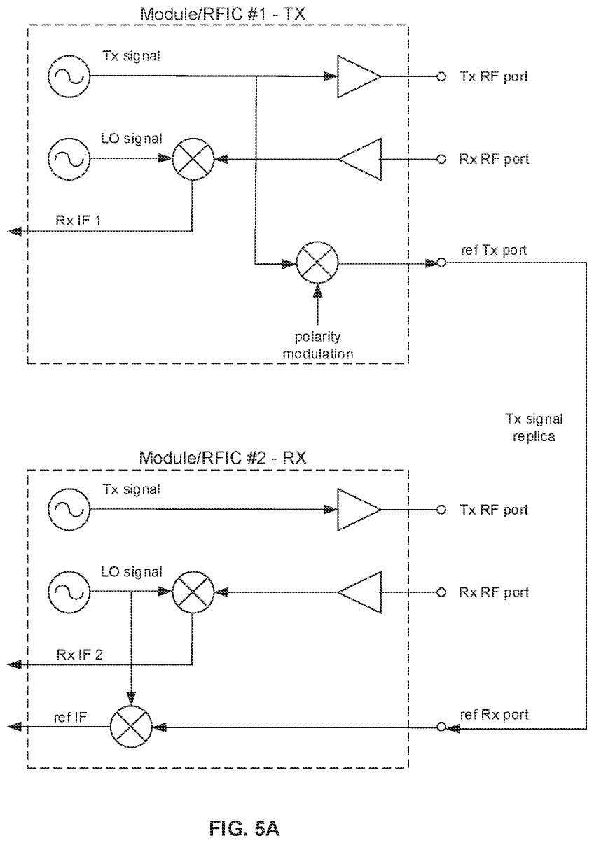

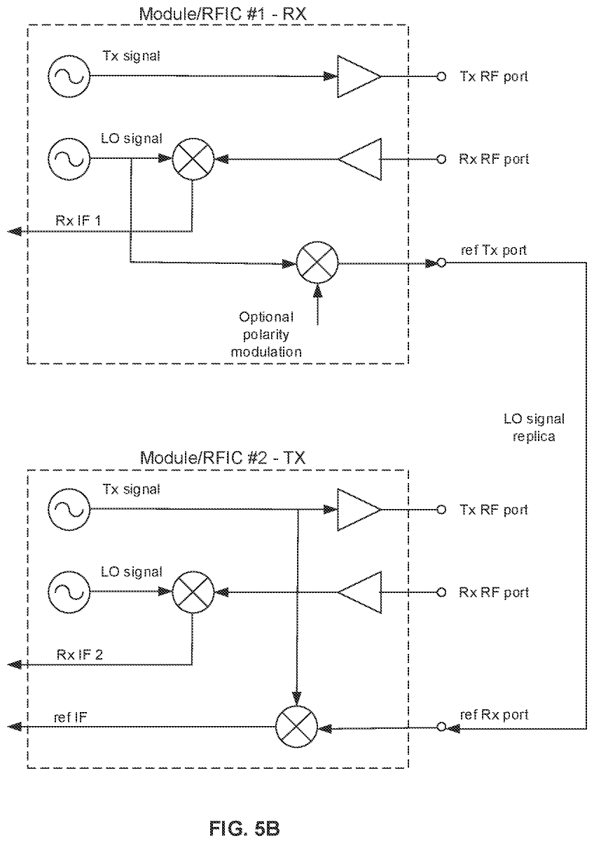

For simplicity and clarity of illustration, elements shown in the figures are not necessarily drawn to scale, and the dimensions of some elements may be exaggerated relative to other elements. In addition, reference labels may be repeated among the figures to indicate corresponding or analogous elements.

### DETAILED DESCRIPTION

Certain embodiments of the present invention provide a reference signal that is distinct from the transmitted signal, so that leakage of the reference signal into the signal from the DUT does not cause a measurement error. In some of these embodiments, the reference signal is mathematically orthogonal to the transmitted signal. According to a related embodiment, orthogonality is attained by frequency offsetting; according to another related embodiment, orthogonality is attained by binary phase shift keying (BSPK), either fast or slow.

In one embodiment, the transmitting RFIC conveys the reference to other RFICs using BPSK (a non-limiting example of which uses 1 MHz modulation). The signal to the DUT is sent as a continuous wave (CW). As a result, the reference signal contains no spectral component at 0 Hz (DC). The receiving RFICs receive both the CW signal from the DUT (on one of the ports) and the BPSK-modulated signal (on another port). The reference signal is BPSK-demodulated, downconverted and integrated in software so as to obtain the reference phasor. Because the reference and the DUT signals are orthogonal, there is no mutual contamination. The BPSK modulation can be implemented through BPSK toggling at the TR module sending the reference (though it can introduce noise)—modulation through arbitrary waveform generation (AWG) is not an option since RFIC₁ is dedicated to generating the transmitted CW signal and RFIC₂ is dedicated to generating the CW receive signal. In an alternative embodiment, BPSK modulation is performed on the local oscillator (LO) signal in the transmitting module receiving the reference.

In another embodiment of the present invention, the transmitting chip conveys the reference to the other chips using BPSK modulation on a snapshot-by-snapshot basis. One snapshot is taken with the reference sent at regular polarity and the other at opposite polarity. The two snapshots are summed for the regular signal and subtracted for the reference signal. The snapshot can be halved in time to maintain same resolution bandwidth (RBW). In a related embodiment, BPSK modulation is implemented through software polarity toggling at the transmitting module (software-based toggling avoids injecting noise).

In a further embodiment, the transmitting RFIC sends to the receiving MC the receive local oscillator (RX_LO) as a reference rather than the transmitted signal. The receiving RFIC is configured to a RX_LO′ frequency which is offset from both the transmitted signal and the RX_LO frequency. In a non-limiting example, the transmitting frequency is 10.010 GHz, RX_LO is 10.008 GHz and RX_LO′ is 10.007 GHz. Then the transmitting RFIC will receive the transmission at 2 MHz, while the receiving RFIC will receive the transmission at 3 MHz and RX_LO at 1 MHz by digitally downconverting the 3 MHz with the received 1 MHz downconverted RX_LO signal. In practice, this is done by multiplying the downconverted 3 MHz samples with conjugate of downconverted 1 MHz samples, Because there is no signal conveyed to the receiving RFIC at the transmitting frequency, the measurement of the signal from the DUT is not contaminated by leakage.

In the above example, if RX_LO′ is higher in frequency than RX_LO (e.g., LO_RX is 10.007 GHz and RX_LO′ is 10.008 GHz) the reference is converted to a “negative frequency” (“−1 MHz”), and during the reconstruction no conjugation is needed.

In respective related embodiments, the above cases extend to arbitrary numbers of multiple receive RFICs, Since only one RFIC transmits at any given time, the processed reference signals are distributed to the other RFICs.

In further embodiments of the present invention, simultaneous transmission is done from multiple RFICs. In a related embodiment, staggered frequencies (by an order of RBW) are used, where the RBW frequency offset does not unsatisfactorily degrade the measurement.

Other embodiments provide BPSK manipulation of the transmitted signals in cases where multiple reference signals need to be distributed. In a related embodiment, BPSK encoding (such as by Hadamard matrix rows) of transmission signals are used to distinguish between the multiple reference signals. In this embodiment, the encodings of the references signals of the RFICs are mutually orthogonal and thus distinguishable. The BPSK code [1 1 . . . 1] is not used, to avoid contaminating the transmitted signal.

A further related embodiment provides multiple RX_LO frequencies, so that the mixed frequency differences are distinct. In a non-limiting example, 4 RFICs with RX_LO frequencies of F₀, F₀+df, F₀+3 df and F₀+4 df, respectively, can be used. The df coefficients 0, 1, 3, and 4 are chosen to avoid overlaps caused by the oscillator±mixing. That is, RFIC₁ will receive at frequencies +df, +3 df, and +4 df, RFIC₂ will receive the references at −df, +2 df and +3 df, etc., such that all absolute values are distinct. The scheme can be further extended for example for 8 RFICs the frequency offsets could be [0,1,3,4,9,10,12,13]df. This technique can be used in conjunction with using the same frequency for transmission and as a local oscillator in each module (such as in FMCW, CW or stepped CW radar), so that each module can receive all the rest of the modules and distinguish between their signals, both in the reference path and in the over-the-air path.

Another embodiment provides orthogonal multiplexing for multi-nodule operation when several modules are transmitting. This embodiment achieves not only the benefits of reference signal isolation, but also a time- and memory-efficient multiple operation per sweep, such as for a multistatic radar application.

An additional embodiment of the present invention further provides a solution to a problem which arises when demodulating a received signal with a signal derived from the same LO as the transmitted signal. Any spur or artifact situated about the LO contributes to an effective noise floor. Examples of such artifacts include: the image components associated with quadrature modulation imbalance and reference spurs situated about the LO. According to this embodiment of the invention, the problem may be avoided in the multi-module case by shifting the LO of each module relative to all others, thus also shifting the associated artifacts.

A further embodiment of the present invention circumvents the need to send a replica of the transmitted signal to the receiving module. Conveying a replica of the transmitted signal to the receiving module allows characterizing the relative phase between the reference signal path and the signal path through the device or medium under test by measuring the relative phase of intermediate frequency signals resulting from the mixing of the received signal with a local oscillator. However, any leakage of the replica of the transmitted signal in the receiver can contaminate the received signal. A related embodiment of the present invention avoids this problem by avoiding sending a replica of the transmitted signal to the receiving module. Instead, this embodiment provides a replica of the receiving module's local oscillator (LO) back to the transmitting module. The transmitting module then locally mixes (via a dedicated downconverter) the receiving module's LO with the transmitted signal, thereby generating an intermediate frequency (IF) at, the transmitter. This transmitter intermediate frequency signal is indicative of the relative phase between the transmitted signal and the receiver's intermediate frequency signal. By performing this operation in the transmitting module rather than in the receiving module, this embodiment guarantees that only the transmitted signal passing through the DUT reaches the receiving module, and that no other signal at same frequency is present there.

It is noted that there are two sets of radar signals involved in the present invention: The primary signals are radar imaging signals emitted from the radar system and reflected back thereto by the radar acquisition targets which are the objectives of the radar imaging process (and which are also reflected back to the radar system by other incidental reflective artifacts in the environment of the radar acquisition targets). Other signals of interest include radar reference signals, which are used for coordination and calibration of the radar system's components. Radar reference signals are distinct from radar imaging signals, in having different characteristics and different functions in radar operation. Furthermore, radar imaging signals and radar reference signals are handled and processed differently, and in general they have different pathways through the radar system.

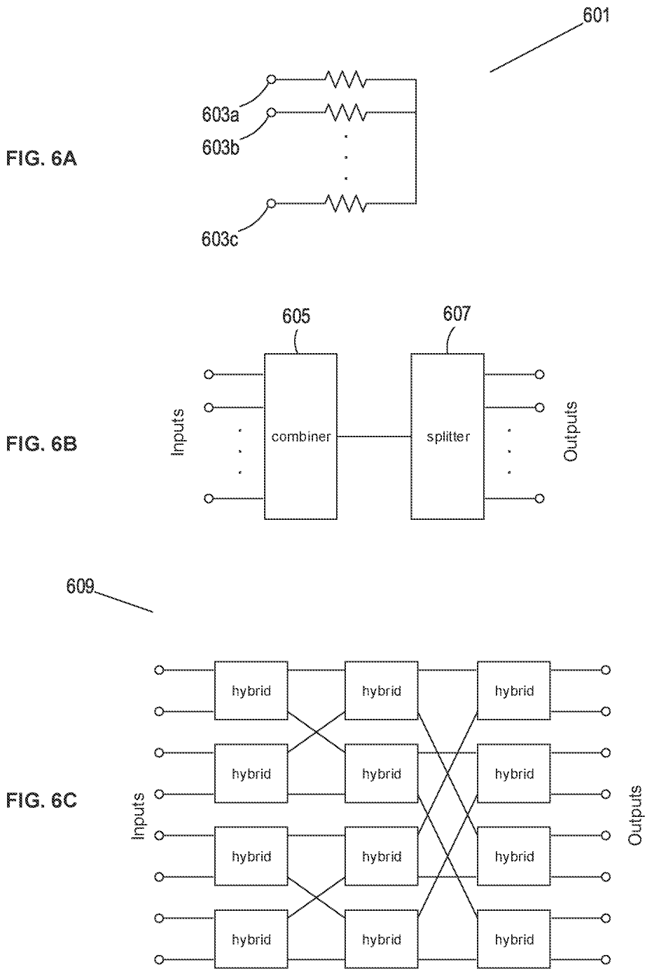

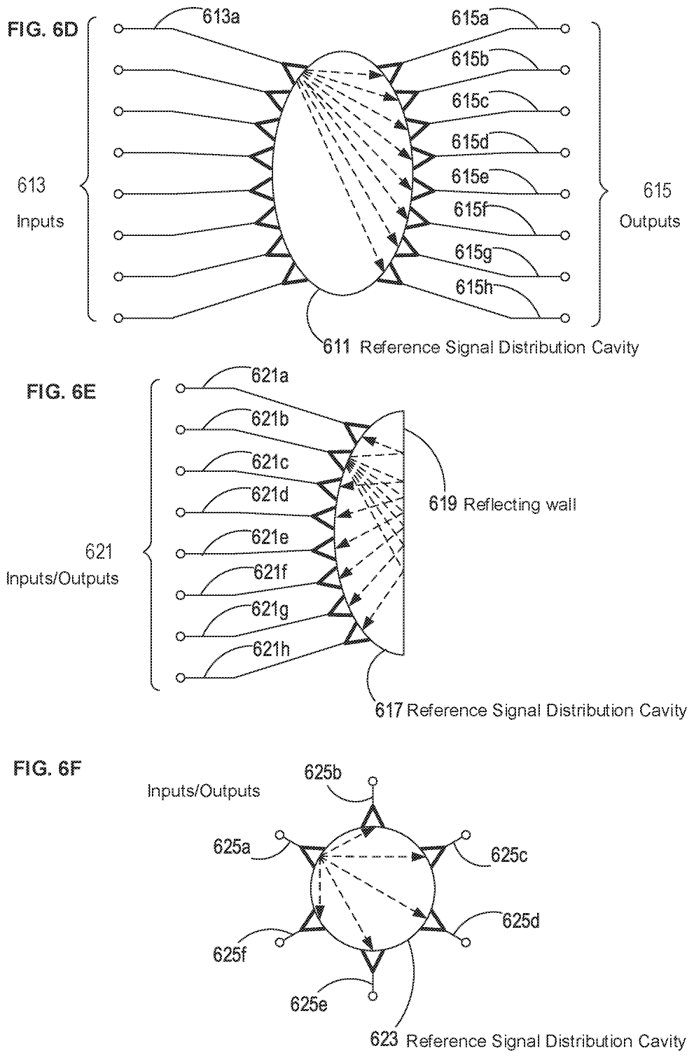

The signal exchange between calibration reference signal output ports and the calibration reference signal input port of a module can be accomplished in various ways. FIG. 6A illustrates an embodiment of the present invention featuring a resistive star coupler 601, in which a reference signal introduced to one of ports 603a, 603b, . . . 603c appears with same attenuation at all other ports. Coupler 601 can be used either with separate output and input ports (by allocating some of coupler ports 603a, 603b, . . . 603c to serve as output ports and other of ports 603a, 603b, . . . 603c to serve as input ports), or with bidirectional calibration ports, which are used alternately as output or input ports.

FIG. 6B illustrates another embodiment of the present invention, in which the reference signals from calibration output ports are aggregated first using a combiner 605, and then a combined reference signal is distributed to the calibration input ports using a splitter 607. This configuration exhibits a loss on the order of 20*log₁₀(N) decibels, due to loss of 10*log₁₀(N) on both the combining operation and splitting operation.

An embodiment of the present invention as illustrated in FIG. 6C decreases the signal losses between the calibration output ports and the input ports by using a cascade of hybrid couplers 609. Each of the hybrid couplers distributes the signal power from each of the input ports between the output ports without absorption (up to implementation losses), and therefore for each input port the signal reaches all the output ports in a tree-like manner, having just 10*log₁₀(N) loss. This structure resembles Butler matrices used in multibeam antennas, with a difference being that the phases can be arbitrary so long as they are fixed and stable. For example, using a cascade of 0/180 degree hybrid couplers results in a Hadamard-like transmission matrix between output and input ports.

Further embodiments of the invention feature Rotman lenses to form reference signal distribution cavities having reflective inner walls with interspersed ports for input and output of signals from the cavities. Rotman lenses are typically used in radar systems as passive network elements for beam-forming of radar imaging signals, such as in phased-array antenna radar systems. In the present invention, however, Rotman lenses are employed in novel arrangements as non-limiting implementations of reference signal distribution cavities, which are illustrated and described herein.

FIG. 6D illustrates an embodiment of the present invention having a reference signal distribution cavity 611 with multiple input ports 613 and multiple output ports 615. For FIG. 6D shows only the distribution of a particular reference signal from a single individual input port 613a to individual output ports 615a, 615b, 615c, 615d, 615e, 615f, 615g, and 615h. A similar distribution of reference signals from all the other input ports 613 also occurs (but is not shown), wherein each of the reference signals from respective individual inputs is distributed to all the output ports 615.

FIG. 6E illustrates a related embodiment of the present invention, wherein a reference signal distribution cavity 617 is a folded version of cavity 611 with a reflecting wall 619, and wherein ports 621 are bidirectional input/output ports. For clarity, FIG. 6E shows only the distribution of particular reference signal from an individual port 621b, operating in an input mode, to individual ports 621a, 621c, 621d, 621e, 621f, 621g, and 621h, all of which are operating in an output mode. A similar distribution of reference signals from each of ports 621a, 621c, 621d, 621e, 621f, 621g, and 621h operating in the input mode also occurs (but is not shown), wherein each of the reference signals from respective individual ports is distributed to all other ports 621 operating in the output mode.

FIG. 6F illustrates another embodiment of the present invention, wherein a reference signal distribution cavity 623 has a substantially circular cross-section, with bidirectional input/output ports 625a, 625b, 625c, 625d, 625e, and 625f arranged in a substantially symmetrical manner along the periphery of cavity 623. For clarity, FIG. 6F shows only the distribution of particular reference signal from an individual port 625a, operating in an input mode, to individual ports 625b, 625c, 625d, 625e, and 625f, all of which are operating in an output node. A similar distribution of reference signals from each of ports 625b, 625c, 625d, 625e, and 625f operating in the input mode also occurs (but is not shown), wherein each of the reference signals from respective individual ports is distributed to all other ports 625 operating in the output mode.

In a related embodiment of the present invention, signals input to a reference signal distribution cavity are distributed according to the distances between the ports of the cavity.

Reference signal distribution in physically large systems often presents practical challenges for efficient and cost-effective implementation. Embodiments of the present invention are particularly well-suited for applications such as high resolution automotive radar and full-body security scanners, where distances between modules can reach tens of centimeters and more. Microwave cables at the microwave and millimeter wave frequencies are costly (especially with appropriate connectors), lossy, and prone to phase variations, such as those encountered in environments subject to varying temperatures.

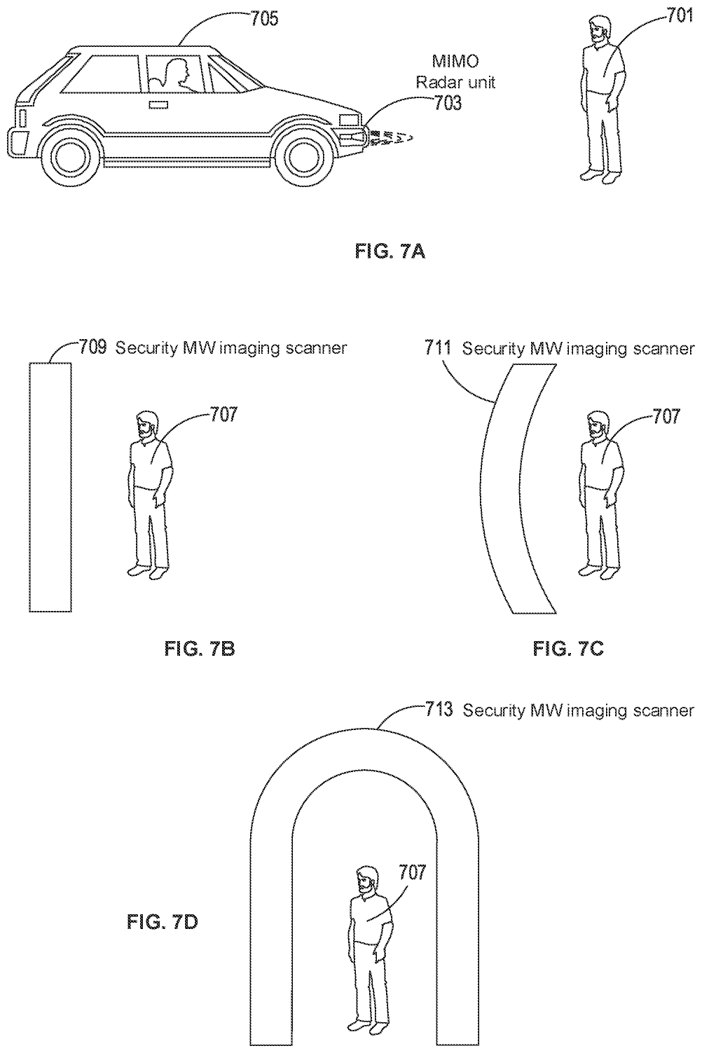

FIG. 7A illustrates an automotive radar environment, wherein a radar acquisition target 701 (a pedestrian) is imaged by a Radar unit 703 installed in an automobile 705. The challenge is to attain a high resolution for imaging small targets such as target 701 with a robust system that functions reliably in the demanding automotive environment, and at the same time in a cost-effective manner consistent with the stringent economic constraints of the marketplace. In such an application, efficient reference signal distribution is critical in supporting sophisticated radar systems that can fulfill the requirements. This goal is met by the distribution components provided by embodiments of the present invention, as detailed herein.

Embodiments of the present invention attain the desired goals by providing reference signal paths in enclosed reference signal distribution cavities, which are not affected by the external environment. In a related embodiment, the reference signal distribution cavity is air-filled, to avoid material-related losses. Other embodiments provide antennas (or similar feed structures) radiating into the cavity through the cavity walls, to which transmit and receive reference signal ports are attached. For example, in certain embodiments featuring printed circuit board (PCB) implementation of the modules, the imaging antennas facing the radar acquisition target are disposed on the front side of the module board(s), whereas the feed antennas for reference signal distribution are disposed on the back side of the module board(s). By attaching the back side of the module board(s) to a reference signal distribution cavity, the reference signal antennas easily connect to the reference signal distribution cavity for efficient reference signal distribution.

A similar situation is found in microwave security systems, which may require even higher imaging resolution. FIG. 7B illustrates a security acquisition target 707 being scanned by a flat security microwave imaging scanner 709; FIG. 7C illustrates security acquisition target 707 being scanned by a curved security microwave imaging scanner 711; and FIG. 7D illustrates security acquisition target 707 being scanned on both sides by a pass-through security microwave imaging scanner 713, which is optionally capable of scanning larger and/or more complex security acquisition targets.

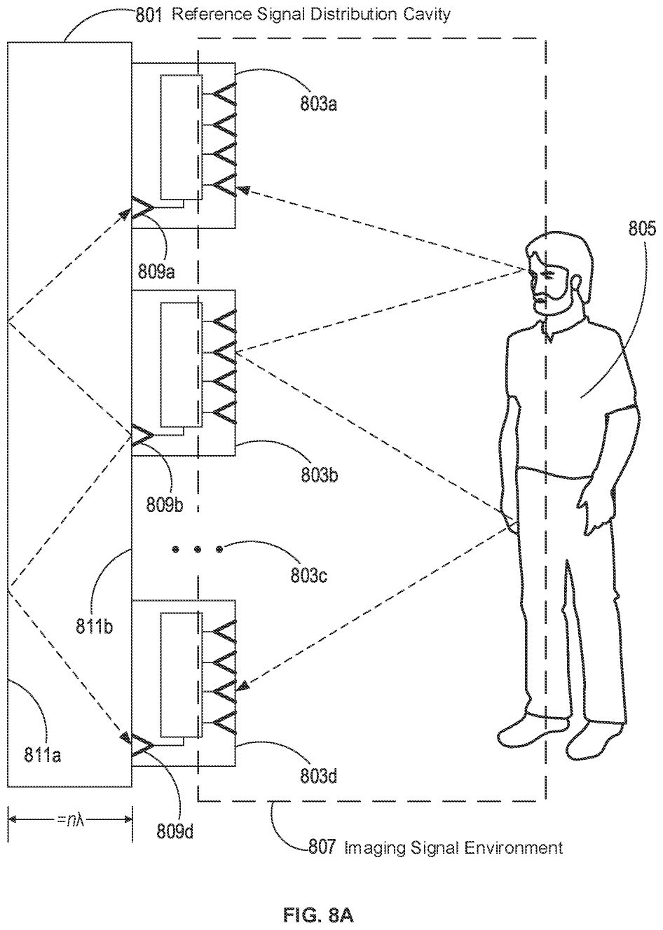

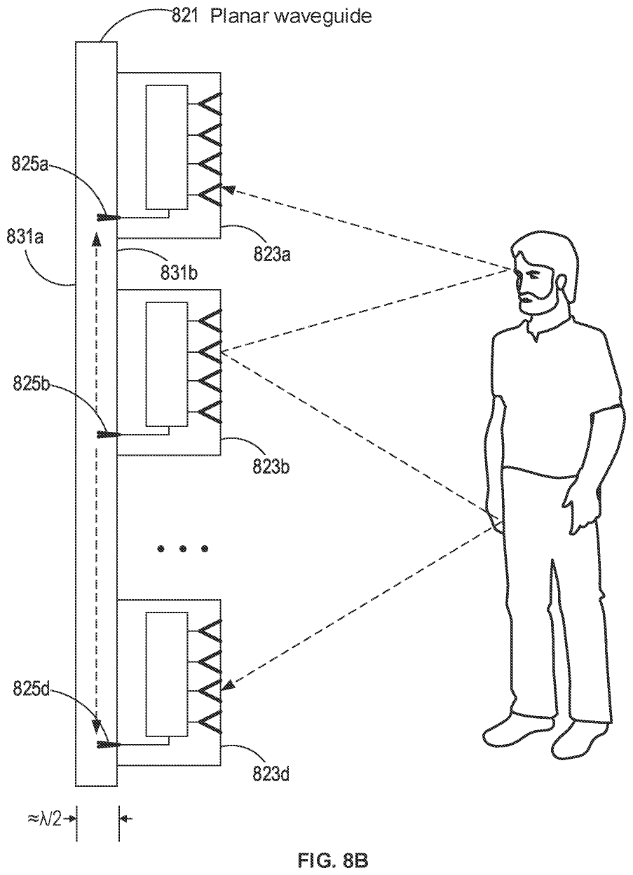

According to further embodiments, a reference signal distribution cavity may take a variety of forms. FIG. 8A illustrates one such embodiment, featuring a reference signal distribution cavity 801 for transmit/receive modules 803a, 803b, and 803d, which transmit and receive radar imaging signals to, and reflected from, a security acquisition target 805. An ellipsis 803c indicates that an arbitrary number of intermediatdy-disposed transmit/receive modules may be included in the set of transmit/receive modules.

Reference signal distribution cavity 801 has a reflecting back side 811a which serves as a mirror separated from a reference signal antenna plane 811b, so that reference signals within cavity 801 reflect during transit between reference signal antennas 809a, 809b, and 809d, all of which lie in plane 811b. In a related embodiment, the distance between planes 811a and 811b is of the order of several wavelengths of the reference signals (=nλ, for a small number n≈2).

While the radar reference signals travel in the confined interior of reference signal distribution cavity 801, the radar imaging signals are transmitted into and received from the open space of an image signal environment 807 existing between modules 803a, 803b, and 803d and security acquisition target 805.

FIG. 8B illustrates another embodiment wherein a reference signal distribution cavity 821 has opposite planes 831a and 831b which are in close proximity, on the order of a half-wavelength (≈λ/2), thereby forming a planar waveguide in which locally injected references signals propagate. Pin antennas 825a, 825b, and 825d protruding into cavity 821 from respective modules 823a, 823b, and 823d couple reference signals between the modules via reference signal distribution cavity 821. According to a related embodiment, the surface of at least part of the interior of cavity 821 is coated with microwave-absorbing material, to avoid multiple reflections and undesired resonances. According to another related embodiment, cavity 821 is rectangular. In a further related embodiment, however, cavity 821 is non-rectangular and conforms to a non-planar arrangement of modules 823a, 823b, and 823d; in a non-limiting example, a cylindrical security scanner cavity 821 has a corresponding cylindrical shape, with opposite walls 831a and 831b being locally.

Where multiple reflections in cavity 821 are not easily avoided, another related. embodiment provides multiple pin antennas (i.e., multiple versions of 825a, 825b, and 825d) per module to counter the multipath effect, along with diversity-combining of the signals received in the multiple pin antennas.

In another embodiment of the invention, a reference signal distribution cavity is filled with a low-loss material. In a non-limiting example, planar waveguide 821 may be implemented using PCB technology on a low-loss substrate.

In a further embodiment, an air-filled parallel-plate waveguide or cavity incorporates supports, fasteners, and so forth, to insure mechanical and thermal stability of the separation between the parallel plates over large areas.

Propagation loss between the ports into a reference signal distribution cavity typically depend on the distance between the ports, giving low-loss priority to nearby ports. Proper design of the reflecting surfaces of the cavity and of the radiation patterns of the feed elements attached to the ports can reduce propagation loss variation to within the order of 10 decibels, thereby reducing the dynamic range requirements for the modules.

What is claimed is:

1. A Radio-Frequency (RF) transmit-receive system comprising:
a plurality of RF transmit-receive modules, wherein each RF transmit-receive module includes:
a reference signal input port;
a reference signal output port; and
a reference signal distribution cavity having
a plurality of reference signal input ports and
a plurality of reference signal output ports;
and wherein
each reference signal output port of a module is connected to an input port of the reference signal distribution cavity;
each reference signal input port of a module is connected to an output port of the reference signal distribution cavity;
and wherein
at least one transmit-receive module is operative to input a reference signal output by another transmit-receive module signal; and
at least one reference signal input to a reference signal input port is distributed, via the reference signal distribution cavity, to at least one reference signal output port.

2. The RF transmit-receive system of claim 1, wherein the reference signal distribution cavity provides a propagation path from each input port to each output port.

3. The RF transmit-receive system of claim 1, wherein the at least one transmit-receive module is operative to input simultaneous reference signals output by more than one other transmit-receive module. 4, The RF transmit-receive system of claim 1, wherein each module of the plurality of modules is operative to input a reference signal output by another transmit-receive module.

5. The RF transmit-receive system of claim 4, wherein each module of the plurality of modules is operative to input reference signals simultaneously output by more than one other transmit-receive module.

6. The RF transmit-receive system of claim 1, wherein at least one transmit-receive module includes a bidirectional input/output port.

7. The RF transmit-receive system of claim 6, wherein each transmit-receive module of the plurality of transmit-receive modules includes a bidirectional reference signal port.

8. The RF transmit-receive system of claim 1, wherein the reference signal distribution cavity includes at least one bidirectional port.

9. The RF transmit-receive system of claim 8, wherein each port of the reference distribution cavity is a bidirectional port.

10. The RF transmit-receive system of claim 7, wherein the bidirectional reference signal port of each transmit-receive module is connected to a bidirectional port of the reference signal distribution cavity.

11. The RF transmit-receive system of claim 1, wherein the reference signal distribution cavity comprises a reflecting surface.

12. The RF transmit-receive system of claim 11, wherein the reflecting surface is spaced at least several wavelengths from a plane of the reference signal input ports and the reference signal output ports.

13. The RF transmit-receive system of claim 1, wherein reference signal distribution cavity is a parallel-plate waveguide.

14. The RF transmit-receive system of claim 1, wherein the reference signal distribution cavity further comprises microwave absorbing elements.

15. The RF transmit-receive system of claim 13, wherein:
each port comprises a pin antenna protruding into the reference signal distribution cavity.

16. The RF transmit-receive system of claim 1, wherein the reference signal distribution cavity has a curved shape.

17. The RF transmit-receive system of claim 1, wherein the reference signal distribution cavity has a planar shape.

18. The RF transmit-receive system of claim 1, wherein signals input to the reference signal distribution cavity are distributed according to the distances between the ports of the cavity.

19. The RF transmit-receive system of claim 1, wherein signals input to the reference signal distribution cavity are distributed among signals output from the reference signal distribution cavity such that the distributed signals are within 10 dB of one another.
